(19) United States
(12) Patent Application Publication
(10) Pub. No.: US 2017/0194088 A1
(43) Pub. Date: Jul. 6, 2017

(54) Isolation Transformer Topology

(71) Applicant: Texas Instruments Incorporated, Dallas, TX (US)

(72) Inventors: Roberto Giampiero Massolini, Pavia (IT); Vijaylaxmi Khanolkar, Pune (IN); Joyce Mullenix, San Jose, CA (US); Rais Miftakhutdinov, Cary, NC (US)

(21) Appl. No.: 14/984,631

(22) Filed: Dec. 30, 2015

(51) Int. Cl. H01F 27/28

(52) U.S. Cl. CPC H01F 27/2885

(57) ABSTRACT

A transformer for module integration includes a first layer of magnetic material having an outer edge, a second layer of magnetic material having an outer edge, and an isolation layer positioned between the first layer of magnetic material and the second layer of magnetic material along a primary axis. The transformer includes a first inductive element positioned in the first layer of magnetic material and a second inductive element disposed opposite of the first inductive element and in the second layer of magnetic material.

### TECHNICAL FIELD

This invention relates generally to transformers, and more particularly to transformers having a high quality factor and used for transferring power across an isolated barrier while using a small form factor and achieving a high isolation rating.

### BACKGROUND

Galvanic isolation is the principle of isolating sections of circuits to prevent current flow between the sections. This can be achieved by capacitive or inductive methods. However, the isolation is frequently a limiting factor in circuit design. High quality isolation transformers typically are wire wound transformers, which are large and expensive. The size of such transformers makes them impractical for smaller footprint circuit designs. Small isolation transformers typically have poor isolation rating. There is a need for a small, affordable isolation transformer with a high isolation rating which would be better suited for module integration.

### SUMMARY

Generally speaking, pursuant to these various embodiments, an isolation transformer includes a particular topology including a first and second inductive element each at least partially embedded in a layer of magnetic material. The magnetic material reduces flux leakage, which both increases the inductance of the transformer and shields against interference between the transformer and the outside circuit. The inductive elements are separated by an isolation layer that limits current leakage between the inductive elements. Such a design allows for a smaller form factor isolation transformer that is readily suitable for modular integration. In particular, transformers with such a topology can have a much smaller profile over other transformers with similar performance characteristics. Use of the magnetic materials also provides for a higher breakdown voltage, which allows for a thinner overall design for the transformer.

These and other benefits may become clearer upon making a thorough review and study of the following detailed description.

### BRIEF DESCRIPTION OF THE DRAWINGS

The above needs are at least partially met through provision of the isolation transformer topology for module integration described in the following detailed description, particularly when studied in conjunction with the drawings, wherein:

FIG. 1 comprises a cross-sectional view of a transformer topology as configured in accordance with a first embodiment of the invention;

FIG. 2 comprises a cross-sectional view of a transformer topology as configured in accordance with a second embodiment of the invention;

FIG. 3 comprises a cross-sectional view of a transformer topology as configured in accordance with a third embodiment of the invention;

FIG. 4 comprises a cross-sectional view of a transformer topology as configured in accordance with a fourth embodiment of the invention;

FIG. 5 comprises a cross-sectional view of a transformer topology as configured in accordance with a fifth embodiment of the invention;

FIG. 6 comprises a cross-sectional view of a transformer topology as configured in accordance with a sixth embodiment of the invention;

FIG. 7 illustrates an perspective view of a transformer as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

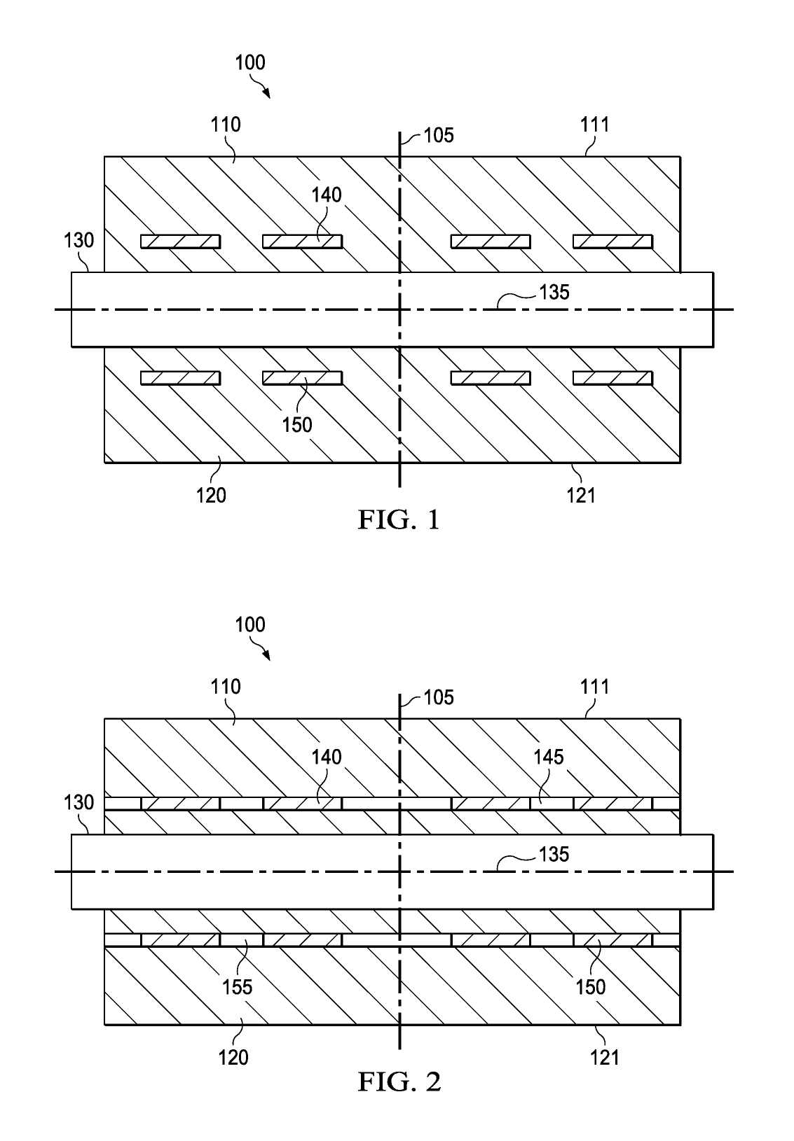

Referring now to the drawings, and in particular to FIG. 1, an illustrative transformer design that is compatible with many of these teachings will now be presented. The transformer 100 has a primary axis 105 and includes a first layer of magnetic material 110 and a second layer of magnetic material 120 separated by an isolation layer 130. The first layer of magnetic material 110, second layer of magnetic material 120, and isolation layer 130 are arranged along the primary axis 105. The first magnetic layer 110 is in a first direction, towards the top of FIG. 1, along the primary axis 105 from the isolation layer 130. The second layer of magnetic material is in a second direction, towards the bottom of FIG. 1, along the primary axis 105 from the isolation layer 130.

The first and second layers of magnetic material 110, 120 can be made of any magnetic material. Possible examples include iron, hematite, steel, nickel, cobalt, and ferrite based materials such a nickel-zinc ferrite, ferrite powder disposed in a binder material, a metal powder material, or other types of magnetic ferrite materials. The isolation layer 130 is composed of an electrical insulator. In some embodiments, the isolation layer 130 is comprised of two or more dielectric laminate layers, such as layers of bismaleimide triazine, FR4, ABF, or any other dielectric material used for substrate or printed circuit board manufacturing.

The first layer of magnetic material 110 has an outer edge 111 facing away from the isolation layer 130. The second layer of magnetic material 120 also has an outer edge 121 facing away from the isolation layer 130. The isolation layer has a center plane 135 that is substantially normal to the primary axis 105.

The transformer 100 also includes two inductive elements 140, 150. The first inductive element 140 is positioned between the outer layer 111 of the first magnetic layer 110 and the center plane 135 of the isolation layer 130. The second inductive element 150 is positioned between the outer layer 121 of the second magnetic layer 120 and the center plane 135 of the isolation layer 130. The two inductive elements 140, 150 are arranged such that when a time-varying electrical current is run through the first inductive element 140 it produces a magnetic field that induces a current in the second inductive element 150. In some embodiments, the so constructed transformer is implemented on a silicon substrate.

The two inductive elements 140, 150 are made of conductive material. Example materials include silver, copper, gold, and aluminum. The inductive elements 140, 150 are wound about a center axis or primary magnetic field producing axis extending in an axial direction. The primary magnetic field producing axes of the two inductive elements 140, 150 are substantially parallel to each other. The shape of the inductive elements 140, 150 can vary. Examples include coils, circles, ellipses, racetrack shapes, squares, rectangles, truncated cones, polygons, or others. In the embodiment shown in FIG. 1, the two inductive elements are shaped to allow current to flow around the primary axis 105 with the axial direction of both inductive elements 140, 150 being substantially parallel to the primary axis 105.

The first inductive element 140 is positioned between the center plane 135 of the isolation layer 130 and the outer edge 111 of the first layer of magnetic material 110. The second inductive element 150 is positioned between the center plane 135 of the isolation layer 130 and the outer edge 121 of the second layer of magnetic material 120. Both inductive elements 140, 150 are surrounded on each side by one of the magnetic material or the isolation layer material. In FIG. 1, the inductive elements 140, 150 are completely embedded in the layers of magnetic material 110, 120 such that a portion of the first layer of magnetic material 110 is disposed between the first inductive element 140 and the isolation layer 130 covering the axial side of the first inductive element 140 facing toward the isolation layer 130, and a portion of the second layer of magnetic material 120 is disposed between the second inductive element 150 and the isolation layer 130 covering the axial side of the second inductive element 150 facing toward the isolation layer 130.

In typical operation, the isolation layer 130 prevents the direct flow of electrical current between the two inductive elements 140, 150. The magnetic layers 110, 120 prevent substantial flux leakage outside of the transformer. This reduced flux leakage results in a high quality factor. The magnetic layers 110, 120 have the added effect of shielding the transformer 100 from electrical interference form the surrounding circuit. The reduced flux leakage also protects the surrounding circuit from interference caused by the transformer 100. The magnetic material of the magnetic layers 110, 120 in the illustrated example of FIG. 1 is disposed to cover the inductive elements 140, 150 on the sides facing away from the isolation layer 130.

In the embodiment shown in FIG. 2, there is a second isolation layer 145 and a third isolation layer 155 added. The inductive elements 140, 150 are surrounded by the second and third isolation layers 145, 155. The second and third isolation layers 145, 155 surround the inductive elements 140, 150 in the directions substantially perpendicular to the axial direction of the inductive elements 140, 150. The second and third isolation layers 145, 155 prevent current from leaking across gaps in the inductive elements 140, 150. In effect, this approach allows for a simplified manufacturing process where the inductive elements 140, 150 and magnetic materials are made and stacked in layers instead of embedding magnetic material within the inductive elements 140, 150.

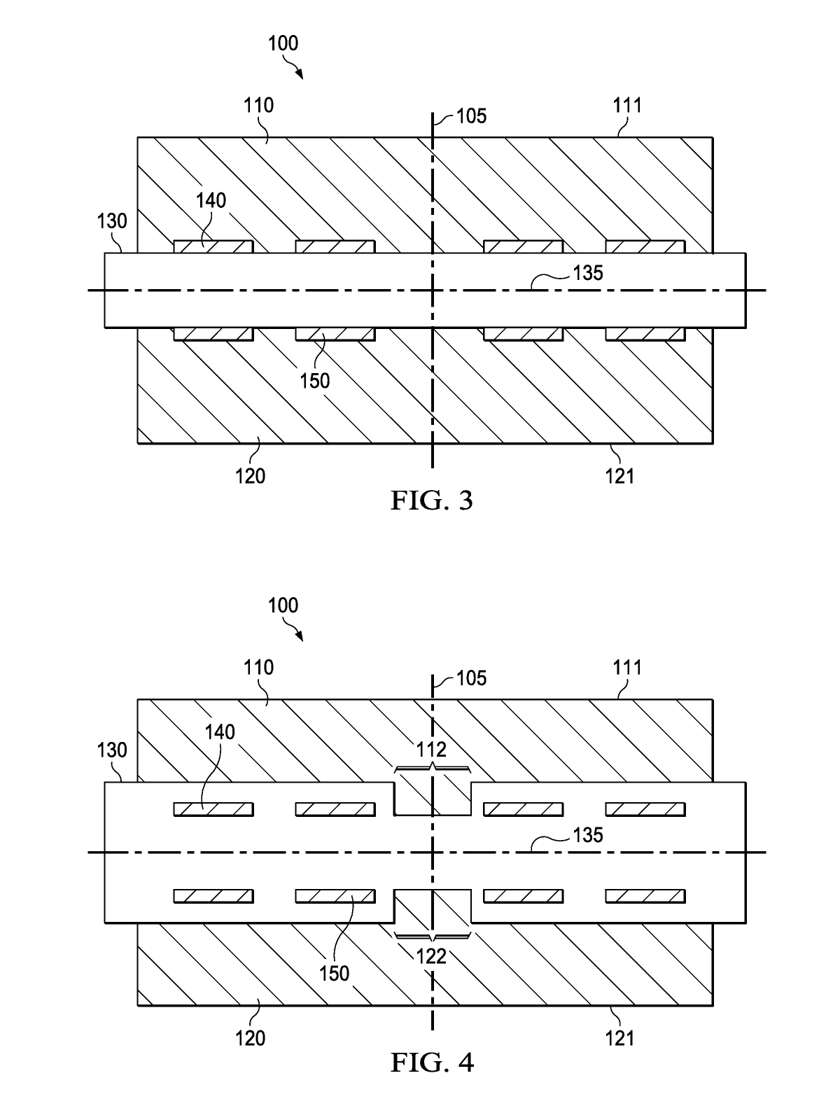

In the embodiment shown in FIG. 3, the inductive elements 140, 150 are disposed along the surface of the isolation layer 130. The inductive elements 140, 150 engage or contact the isolation layer 130 on one side and are surrounded by magnetic material on all other sides, and magnetic material extends in between the windings of the inductive elements 140, 150. The magnetic layers 110, 120 around the inductive elements 140, 150 still prevent flux leakage, and the lack of magnetic material between the inductive elements 140, 150 allows for a high coupling coefficient.

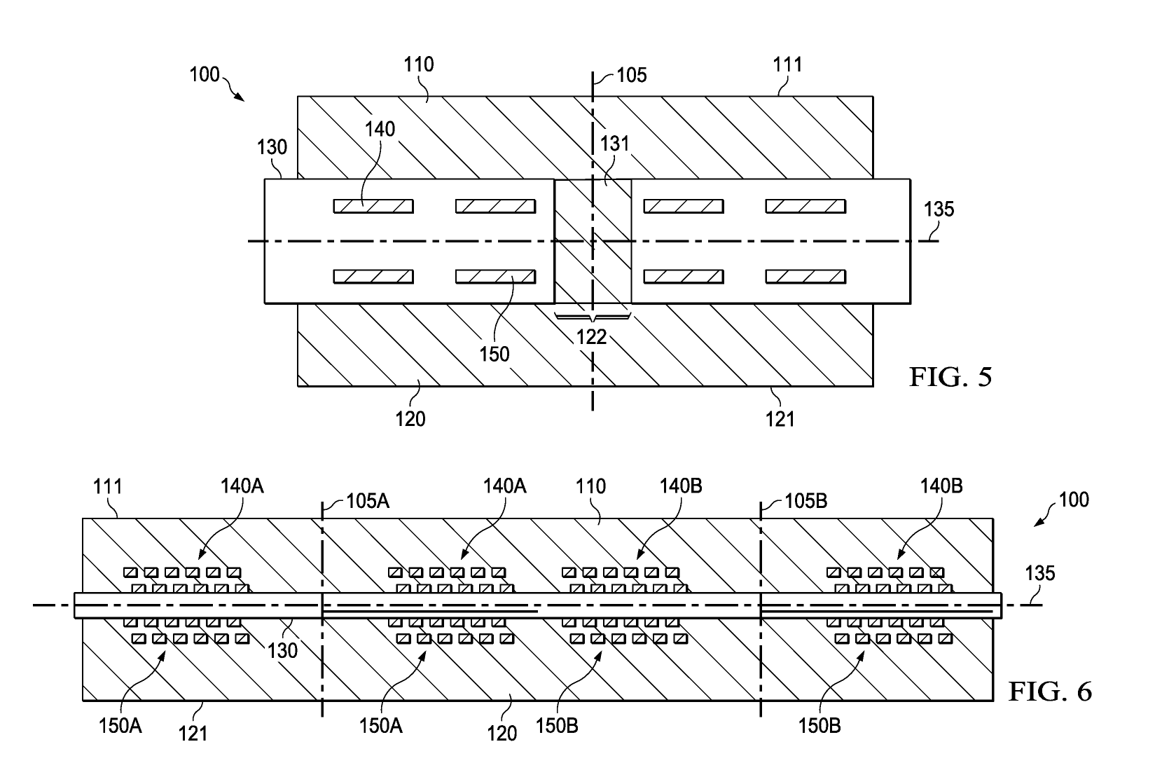

As shown in the example of FIG. 4, the inductive elements 140, 150 can be fully embedded in the isolation layer 130. The insulating material prevents current leaking across gaps in the inductive elements 130, 140, increasing the quality factor. There are indentations 112, 122 in the isolation layer 130 at least partially filled with the magnetic material. The indentations 112, 122 define voids extending into respective surfaces of the isolation layer. In other words, the indentations 112, 122 extend parallel to the primary axis 105 and at least partially filled with the magnetic material, which in one approach extend inward from the first and second layers of magnetic materials 110, 120 towards the center plane 135 until at least even with the inner most surface of the inductive elements 140, 150. This magnetic material provides a smaller gap in the magnetic flux path between inductive elements and results in a higher coupling coefficient.

The indentation 122 in the isolation layer 130 at least partially filled with magnetic material can extend all the way through the isolation layer 130 as shown in the example of FIG. 5. In this example, the indentation 122 in effect is a though hole via 131. The via 131 can be partially filled with magnetic material 125 with the remainder filled with a filler 133 such as a glue or material. The amount of filler 133 relative to the amount of magnetic material 125 in the through hole via 131 determines the amount of air gap in the magnetic flux path. Thus, the transformer's coupling coefficient and quality factor can be specifically tailored to a given application. For example, this arrangement can be used in an application requiring high inductance density such as in a low power isolated DCDC for industrial automation. The high inductance density will make this transformer suited for traditional PWM converter as well as flyback or full bridge solutions.

In an alternative embodiment, as shown in FIG. 6, the transformer 100 includes more than one set of inductive elements 140, 150. In the first layer of magnetic material 110, there is a first top inductive element 140A and a second top inductive element 140B. In the second layer of magnetic material 120, there is a first bottom inductive element 150A and a second bottom inductive element 150B. When current passes through the first top inductive element 140A it creates a magnetic field that induces a current in the first bottom inductive element 150A. When a current passes through second top inductive element 140B it creates a magnetic field that induces a current in the second bottom inductive element 150B. The first set of inductive elements 140A, 150A are wound about an axis 105A that extends in an axial direction. The second set of inductive elements 140B, 150B are wound about an axis 105B that extends in the same, or substantially the same, direction.

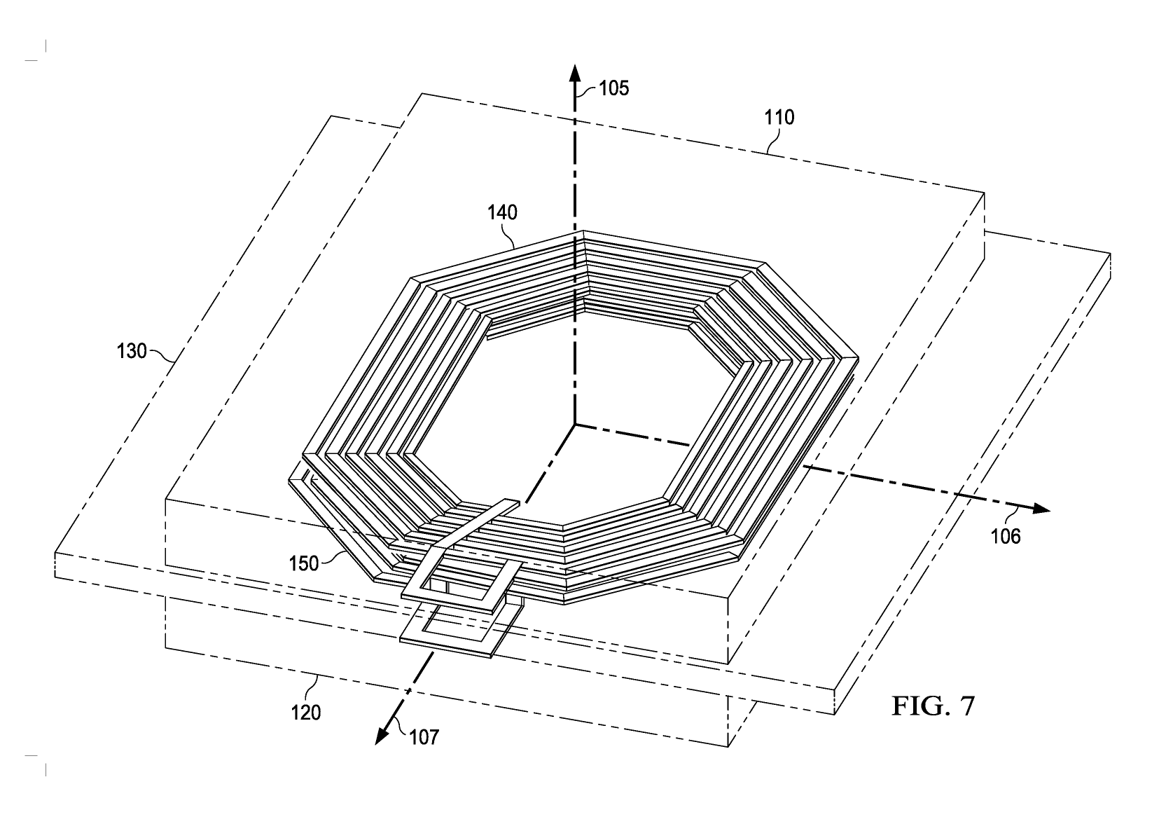

FIG. 7 illustrates an isometric view of one form for the transformer 100. The inductive elements 140, 150 are wound about an axis extending in an axial direction 105. The inductive elements are wound in the two radial directions 106, 107. The first inductive element 140 is at least partially embedded in the first layer of magnetic material 110. The second inductive element 150 is at least partially embedded in the second layer of magnetic material 120. The two inductive elements 140, 150 are on opposing sides of the isolation layer 130. The first layer of magnetic material 110 extends from the isolation layer 130 past the first inductive element 140 in the axial direction. The first layer of magnetic material 110 also extends past each side of the inductive element 140 in the radial directions 106, 107. In this way the inductive element 140 is completely surrounded by magnetic material. Similarly the second layer of magnetic material 120 extends from the isolation layer 130 to completely surround the second inductive element 150 in the axial 105 and radial directions 106, 107.

In an alternative embodiment, the first and second inductive elements 140, 150 are disposed on the surface of the isolation layer 130. The magnetic material extends to cover the inductive elements in the radial directions 106, 107 as well in the axial direction 105 on the faces of the inductive elements 140, 150 facing away from the isolation layer 130. The inductive elements 140, 150 are surrounded by the isolation layer 130 or the layers of magnetic material 110, 120 on every side.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a transformer comprising:
a first inductive element having its primary magnetic field producing axis extending in an axial direction;
a second inductive element having its primary magnetic field producing axis extending in the axial direction; and
an isolation layer disposed between the first inductive element and the second inductive element in the axial direction;
wherein
magnetic material is disposed to cover the first inductive element and the second inductive element on respective axial sides of the first inductive element and the second inductive element opposite the isolation layer, and
one of the isolation layer and the magnetic material is disposed to cover axial sides of the first inductive element and the second inductive element facing toward the isolation layer.

2. The apparatus of claim 1, wherein the magnetic material is disposed to cover the axial side of the first inductive element facing toward the isolation layer and to surround the first inductive element.

3. The apparatus of claim 1, wherein the isolation layer is disposed to cover the axial side of the first inductive element facing toward the isolation layer and wherein the magnetic material is disposed to surround the first inductive element.

4. The apparatus of claim 1, the transformer further comprising:
a second isolation layer positioned such that the first inductive element is surrounded by the second isolation layer in a direction perpendicular to the axial direction.

5. The apparatus of claim 1, further comprising:
at least a third inductive element wound about an axis extending in the axial direction and disposed on a side of the isolation layer on which the first inductive element is disposed;
at least a fourth inductive element wound about an axis extending in the axial direction and disposed on a side of the isolation layer on which the second inductive element is disposed;
wherein the magnetic material is disposed to cover the third inductive element and the fourth inductive element on respective axial sides of the third inductive element and the fourth inductive element opposite the isolation layer.

6. The apparatus of claim 1, wherein the first inductive element, second inductive element, and isolation layer are implemented in a silicon substrate.

7. An apparatus comprising:
a transformer comprising:
a first inductive element wound around an axial direction and wound in a radial direction, the first inductive element being at least partially embedded in a first magnetic layer;
an isolation layer;
a second inductive element wound around an axial direction and wound in a radial direction, the second inductive element at least partially embedded in a second magnetic layer;
wherein the first inductive element and the second inductive element are disposed on opposing sides of the isolation layer;
wherein the first magnetic layer extends from the isolation layer past the first inductive element in the first inductive element's axial direction and extends past the first inductive element in the first inductive element's radial direction such that the first inductive element is surrounded by either the first magnetic layer or the isolation layer;
wherein the second magnetic layer extends from the isolation layer past the second inductive element in the second inductive element's axial direction and extends past the second inductive element in the second inductive element's radial direction such that the second inductive element is surrounded by either the second magnetic layer or the isolation layer.

8. The apparatus of claim 7, wherein the first inductive element is surrounded by the first magnetic layer such that a portion of the first magnetic layer is also disposed between the first inductive element and the isolation layer.

9. The apparatus of claim 7, wherein the second inductive element is surrounded by the second magnetic layer such that a portion of the second magnetic layer is also disposed between the second inductive element and the isolation layer.

10. The apparatus of claim 7 wherein a portion of the first inductive element engages the isolation layer and the first magnetic layer extends in between windings of the first inductive element.

11. The apparatus of claim 7, wherein a portion of the second inductive element engages the isolation layer and the second magnetic layer extends in between windings of the second inductive element.

12. An apparatus comprising:
a transformer comprising:
a first layer of magnetic material having an outer edge;
a second layer of magnetic material having an outer edge;
an isolation layer positioned between the first layer of magnetic material and the second layer of magnetic material along a primary axis, the isolation layer having a center plane substantially normal to the primary axis;
a first inductive element wound about an axis substantially parallel to the primary axis; and
a second inductive element wound about an axis substantially parallel to the primary axis, wherein
the first layer of magnetic material is positioned in a first direction along the primary axis from the isolation layer with the outer edge of the first layer of magnetic material being opposite the isolation layer,
the second layer of magnetic material is positioned in a second direction along the primary axis from the isolation layer with the outer edge of the second layer of magnetic material being opposite the isolation layer,
the first inductive element being positioned between the center plane of the isolation layer and the outer edge of the first layer of magnetic material, and
the second inductive element being positioned between the center plane of the isolation layer and the outer edge of the second layer of magnetic material.

13. The apparatus of claim 12, wherein the first inductive element is embedded in the first layer of magnetic material.

14. The apparatus of claim 12, wherein the first inductive element is embedded in the isolation layer.

15. The apparatus of claim 12, the transformer further comprising:
a second isolation layer positioned such that the first inductive element is surrounded by the second isolation layer in a direction perpendicular to the primary axis.

16. The apparatus of claim 12, wherein a side of the first inductive element facing the second direction is disposed along a surface of the isolation layer facing the first direction.

17. The apparatus of claim 12, wherein the isolation layer has at least one indentation defining a void extending into a surface of the isolation layer, the indentation extending parallel to the primary axis and at least partially filled with a magnetic material.

18. The apparatus of claim 17 wherein the indentation of the isolation layer defines a hole through the isolation layer.
